(19) United States
(12) Patent Application Publication
(10) Pub. No.: US 2009/0242615 A1
(43) Pub. Date: Oct. 1, 2009

(54) PROCESS FOR JOINING MATERIALS USING A METALLIC HEAT SOURCE WITHIN A CONTROLLED ATMOSPHERE

(76) Inventors: Neeraj Saxena, Murray Hill, NJ (US); Kevin McKeigue, Berkeley Heights, NJ (US)

Correspondence Address: The BOC Group, Inc., 575 MOUNTAIN AVENUE, MURRAY HILL, NJ, 07974-2082, US

(21) Appl. No.: 12/477,326

(22) Filed: Jun. 3, 2009

Related U.S. Application Data
(63) Continuation of application No. 11/781,286, filed on Jul. 23, 2007.
(60) Provisional application No. 60/820,131, filed on Jul. 24, 2006.

(51) Int. Cl. B23K 31/02

(52) U.S. Cl. 228/198

(57) ABSTRACT

This invention is directed to a process for joining materials comprising providing an assembly comprising at least one material layer; at least one metal heat source; and at least one solder layer, each solder layer disposed between each metallic heat source and each material layer; placing the assembly in a controlled atmosphere; and initiating a chemical reaction in the metal heat source so as to enable the solder to join the material layer.

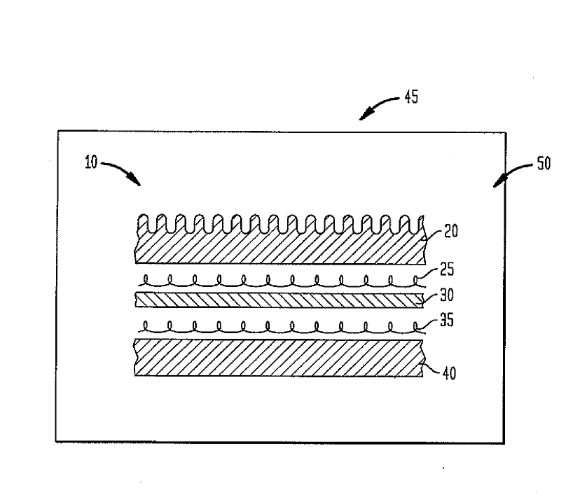

### CROSS REFERENCE TO RELATED APPLICATIONS

The present application is a continuation application of U.S. patent application Ser. No. 11/781,286, filed 23 Jul. 2007 which claims priority from U.S. Provisional Patent Application Ser. No. 60/820,131, filed 24 Jul. 2006.

### FIELD OF THE INVENTION

The present invention relates to a process for joining materials, and more specifically, a process for joining materials using a nanoscale layer of metals within a controlled atmosphere.

### BACKGROUND OF THE INVENTION

The art has developed processes for soldering (and brazing) which uses a nano-structured foil to rapidly deliver a precise amount of heat to the parts to be joined. The nanofoil consists of nano-scale layers of Al and Ni which, upon initiation of a highly exothermic mixing reaction, combine to form an alloy. By choosing an appropriate foil thickness, the amount of heat delivered to the parts to be joined can be precisely controlled. This allows sufficient heat to be released to fully melt the solder or brazing material without delivering excess heat to the joined parts. Because so little heat is released, it dissipates rapidly after ignition resulting in temperatures just a few millimeters away from the interface never rising significantly above ambient. See, U.S. Pat. Nos. 5,538,795 and 5,547,715, both to Barbee, Jr. et al.

One targeted application for this technology is electronic packaging (soldering RF connectors, integrated circuits (ICs) and other electronic components to printer circuit boards (PCBs) and soldering heat sinks to IC packages) where the nanofoil takes the place of the furnace for reflow soldering. The soldered components never reach furnace temperatures so significantly less heat damage would be expected.

In precision part joining, the nanofoil substitutes for the welding or brazing torch as the heat source. It is expected that less distortion of the precision parts would occur using the nanofoil process.

The nanofoil process currently can be used only with surfaces that are clean and virtually oxide-free. This requires that the surfaces either be plated with a non-oxidizing metal such as gold, or cleaned chemically and/or mechanically immediately prior to joining to expose the metal surface. Liquid and paste fluxes apparently are ineffective with the nanofoil process. Because the solder remains melted for such a short time, the residual flux and the flux reaction products do not have sufficient time to flow away from the interface and thus do not allow the surfaces to be joined to come into contact.

Accordingly, there is a need in the art for a process that permits nanofoil-based bonding to be used when the materials to be joined encounter light surface oxide layers.

### SUMMARY OF THE INVENTION

This invention is directed to a process for joining materials comprising providing an assembly comprising at least one material layer; at least one metal heat source; and at least one solder layer, each solder layer disposed between each metallic heat source and each material layer; placing the assembly in a controlled atmosphere; and initiating a chemical reaction in the metal heat source so as to enable the solder to join the material layer.

In another embodiment, this invention is directed to a process for joining materials comprising providing an assembly comprising a plurality of material layers; at least one metal heat source; and a plurality of solder layers, each solder layer disposed between each metallic heat source and each material layer; placing the assembly in a controlled atmosphere; and initiating a chemical reaction in the at least one metal heat source so as to enable the solder to join the material layer.

In yet another embodiment, this invention is directed to a process for joining metal devices using an exothermic heat source within a controlled atmosphere comprising: providing an assembly comprising a plurality of electronic devices; an exothermic heat source between the electronic devices; and a plurality of solder layers, each solder layer disposed between the exothermic heat source and each of the electronic devices; placing the metal assembly in a controlled atmosphere; and initiating a chemical reaction in the at least one metal heat source so as to enable the solder to join the metal layer.

The material layer is chosen from a metal, a semiconductor, or a ceramic material. In another embodiment, the material layer is chosen from any combination of a metal, a semiconductor or a ceramic material.

In an embodiment of this invention, the assembly comprises two material layers. In an embodiment, the material layer comprises two metal layers. In an embodiment, the material layers comprise an electronic device and metal. In another embodiment, the materials layers comprise an electronic device and a heat sink.

In this invention, the solder layer comprises tin, lead, silver, copper, antimony, zinc, bismuth, indium or any of its combination thereof. The solder layer may be in the form of a foil of one or several layers, a coil or a paste.

The heat source comprises a multilayer structure that provides an exothermic reaction. The multilayer structure is a two-atom nanostructure selected from a group consisting of NiSi, VB₂, TlB₂, Monel/Al 400, NiAl, PdAl, TiSn, SnV, ZrAl and TiAl. In an embodiment, the nanostructure is NiAl.

### BRIEF DESCRIPTION OF THE DRAWINGS

While the specification concludes with claims distinctly pointing the subject matter that applicants regard as their invention, it is believed that the invention would be better understood when taken in connection with the accompanying drawings in which the figure is a perspective view of the assembly in a controlled atmosphere as embodied in this invention.

### DETAILED DESCRIPTION OF PREFERRED EMBODIMENTS

The invention relates to a process that permits material layers, including but not limited to nanofoil-based, bonding to be used when the materials to be joined have light surface oxide layers. This is accomplished by having the process take place in a controlled atmosphere. In an embodiment, the controlled atmosphere is a reducing atmosphere.

At least one of the following process steps is contemplated. First, an assembly step comprises one of the two parts of materials 20, 40 to be joined, the first material part typically being an electronic device. Typically, the electronic device is heat generating. The composition and type of electronic device is known to those skilled in the art. In one embodiment, at least one of the two parts of the materials 20, 40 is a metal. In another embodiment, at least one of the two parts of the materials 20, 40 is a semiconductor. In yet another embodiment, at least one of the two parts of the materials 20, 40 is a ceramic material.

A layer of soldering material 25 (or 35) is then placed adjacent to the electronic device. The soldering material may be comprised of tin, lead, silver, copper, antimony, zinc, bismuth, indium or any combination thereof. The soldering material may be in the form of a foil. In other embodiments, the soldering material may be in a paste form.

Following the layer of soldering material is an unreacted multilayer structure 30, i.e., in two alternating separate layers A and B. that can release energy. The chemical reaction between the elemental components in unreacted A and B determines the energy available. The rate at which the energy is released is directly proportional to the rate at which these atoms react by thermally activated processes or by structurally enhanced mixing. Because these reactions are thermally activated, the higher the sample temperature, the higher the rate of reaction. Additionally, a significant parameter of the invention is that the number of atoms in close contact near an interface determines the rate of interfacial atoms, the higher the rate of heat release. Therefore the reaction delivered power is proportional to the interfacial area per unit volume.

Multilayer structures 30 of various energy levels are available. The heats of formation are about 100 to 200 k joules/mole. Higher energy multilayer structures, typically from about 70 to 120 kjoules/moles include, but are not limited to, NiSi, VB₂, and TiB₂. Mid-range multilayer structures, typically from about 45 to 70 kjoules/moles include, but are not limited to, Monel/Al 400, NiAl, PdAl, TiSn and SnV. Lower-range multilayer structures, typically from about 20 to 45 kjoules/moles include, but are not limited to, ZrAl and TiAl.

The multilayer structures of the present invention have wide spread applications, including use as igniters, in joining applications, in fabrication of new material, as smart materials and medical devices and therapies. In the application of igniters, multilayer structure can be a reaction initiator, wide area heating device or timed explosive initiator. Joining applications include composite of metals, semiconductors (low temperature), ceramics, honeycombs, in the field repairs and as a low energy replacement for spot or arc welding or joining with the same material.

Suitable multilayer igniters include Monel/Al 400, NiAl, ZnAl, NiSi, MoSi, PdSi, PdAl and RhAl. As an example, but not intended to limit the invention, an Al/Monel 400 igniter can be made having a heat of formation of about 55 kcal/mole. However, its sensitivity may be too high at small periods. Another igniter is ZrAl₃ or ZrAl₂ each with a heat of formation of about 45 kcal/mole. An advantage of these materials is that they have lower heats of formation, are less sensitive to smaller periods and require less energy to ignite. The igniter TiAl has a heat of formation of 33-35 kcal/mole. Further details on ignitable multilayer structures are found in U.S. Pat. Nos. 5,538,795 and 5,547,715.

By way of example, and not intended to be limiting, the metallic layer 30 may be a metallic foil comprised of nanostructures. In an embodiment of this invention, the metallic layer 30 may be described as nanofoils. In another embodiment, this layer 30 is a nanoscale layer of material.

Following the metallic layer 30 is a second layer of soldering material 35 (or 25). As described above, the soldering material may be in the form of a foil. In other embodiments, the soldering material maybe in a paste form. Following the layer of the second soldering material is the second metal layer to be joined, the second metal part typically being a circuit heat sink. The circuit heat sink may be comprised of copper, aluminum or silicon, or any combination thereof. In other embodiments, the silicon may be comprised of silicon dioxide.

The second process step involves placing the assembly in a location 45 where the atmosphere 50 is controlled to have a composition that facilitates the reduction of the oxide layer to its metallic form. The location may be an atmosphere controlled chamber. Alternatively, the location may be a place, outside of or not within an atmosphere controlled chamber, to which a flow of gas is directed to effectively shields the location from the ambient atmosphere.

Generally, an oxide layer may exist where a metal 20 (or 30) has been stored for extended periods under atmospheric conditions. Also, an oxide layer may exist where heat is generated in metallic heat source 30 in the presence of oxygen, i.e., atmospheric conditions. It is believed that the resulting oxide layer may cause detrimental effects such as inhibiting adhesion between the metals 20 and 30. However, by operating this process in a reducing atmosphere, the following chemical reaction is believed to take place:

a. H₂+MO+heat→H₂0+M, where MO is metal oxide and M is metal. The above reaction is similarly formed in semiconductors and ceramic materials.

The reducing atmosphere may comprise hydrogen, mixtures of hydrogen and nitrogen, or mixtures of hydrogen and an inert gas such as argon. For any of these reducing atmospheres, the amount of oxygen present should be <100 ppm. In other embodiments, the amount of oxygen present should be <10 ppm. In further embodiments, the amount of oxygen present should be <1 ppm.

The concentration of water in the atmosphere should be preferably <50 ppm.

As used herein, the gas mixtures are used for the reducing atmosphere, the hydrogen concentration should be >30%.

As used herein, the H₂/H₂O ratio, expressed in terms of molar or volume concentrations, should be >10. In other embodiments, the H₂/H₂O ratio, expressed in terms of molar or volume concentrations, should be >100.

The pressure can be atmospheric. In other embodiments, the pressure may be less than atmospheric, such as less than about 100 Torr. In other embodiments, the pressure may be less than or equal to about 10 Torr absolute.

As discussed above, the present invention relates to joining materials including, but not limited to, 1) two metals, 2) a metal and a semiconductor and 3) a metal and a ceramic material. In the case that when at least one of the materials being joined is a ceramic material, it should be noted that the nature of the bonding between the igniter with the ceramic material will not require the removal of the metal oxide that is formed between the igniter and the ceramic material.

The third process step involves subjecting the assembly to a force which causes layers to come into close contact.

The final process step involves initiating the mixing reaction within the nanofoil layer (preferably using a laser or electrical arc as the ignition source, but optionally by other means) to cause the heat of mixing to be released which causes the solder to melt and the temperature of the surfaces of the parts to be raised to a temperature at which the reduction of the surface oxide takes place.

The process described above can also be used for brazing if a layer of suitable brazing material is substituted for the layer of solder.

This invention provides the advantage of allowing parts with light surface oxide layers to be joined. It eliminates the need for either pre-joining removal of the surface oxide or gold plating of the surfaces.

It will be understood that the embodiment(s) described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

What is claimed is:

1. A process for joining a first material layer and a second material layer comprising:
providing an assembly comprising
the first material layer;
a first solder layer on the first material layer;
a metal heat source layer on the first solder layer;
a second solder layer on the metal heat source layer; and
the second material layer on the second solder layer;
wherein a surface oxide coating layer exists on at least one of the first material layer at the interface with the first solder layer, or the metal heat source layer at the interface with either the first solder layer or the second solder layer, or the second material layer at the interface with the second solder layer;
placing the assembly in a controlled atmosphere; and
initiating a chemical reaction in the metal heat source layer to release heat to reduce the surface oxide coating layer and to melt the first solder layer and the second solder layer to join the first material layer to the second material layer.

2. The process of claim 1 wherein the first material layer is a metal layer and the second material layer is a metal layer.

3. The process of claim 1 wherein the first material layer is a metal layer and the second material layer is an electronic device.

4. The process of claim 2 wherein the first material layer is a heat sink.

5. The process of claim 1 wherein the first material layer is a metal layer, a semiconductor layer or a ceramic layer.

6. The process of claim 1 wherein the first solder layer and the second solder layer are the same or different and are composed of tin, lead, silver, copper, antimony, zinc, bismuth, indium or any combination thereof.

7. The process of claim 1 wherein the metal heat source layer comprises a multilayer structure that reacts exothermically.

8. The process of claim 7, wherein the multilayer structure is a two-atom nanostructure selected from a group consisting of NiSi, VB₂, TiB₂, Monel/Al 400, NiAl, PdAl, TiSn, SnV, ZrAl and TiAl.

9. The process of claim 8, where is the multilayer structure is NiAl.

10. The process of claim 1, wherein the controlled atmosphere is a reducing atmosphere.

11. The process of claim 10, wherein the reducing atmosphere comprises hydrogen, a mixture or of hydrogen and nitrogen, or a mixture of hydrogen and an inert gas.

12. The process of claim 1 wherein the first material layer is an electronic device and the second material layer is an electronic device.
